(19) United States
(12) Patent Application Publication
(10) Pub. No.: US 2020/0229400 A1
(43) Pub. Date: Jul. 23, 2020

(54) Pet Controlling Leash Extension

(71) Applicant: Fred Westerbeke, East Marion, NY (US)

(72) Inventor: Fred Westerbeke, East Marion, NY (US)

(21) Appl. No.: 16/253,403

(22) Filed: Jan. 22, 2019

(51) Int. Cl. A01K 27/00

(52) U.S. Cl. CPC A01K 27/003; A01K 27/002

(57) ABSTRACT

A pet controlling leash extension for safely controlling a dog includes an extension bar, a harness ring, a leash ring, and a handle. The extension bar has a harness end and a leash end. The harness ring is coupled to the harness end and is configured to selectively engage with a harness. The leash ring is coupled to the leash end and is configured to receive a leash. The handle has a handle clip. The handle clip is selectively engageable with the leash ring.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to leash accessories and more particularly pertains to a new leash accessory for safely controlling a dog.

### (h) BRIEF SUMMARY OF THE INVENTION

An embodiment of the disclosure meets the needs presented above by generally comprising an extension bar, a harness ring, a leash ring, and a handle. The extension bar has a harness end and a leash end. The harness ring is coupled to the harness end and is configured to selectively engage with a harness. The leash ring is coupled to the leash end and is configured to receive a leash. The handle has a handle clip. The handle clip is selectively engageable with the leash ring.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a pet controlling leash extension according to an embodiment of the disclosure.

FIG. 2 is a top plan view of an embodiment of the disclosure.

FIG. 3 is a side elevation view of an embodiment of the disclosure.

FIG. 4 is an in-use view of an embodiment of the disclosure.

### (j) DETAILED DESCRIPTION OF THE INVENTION

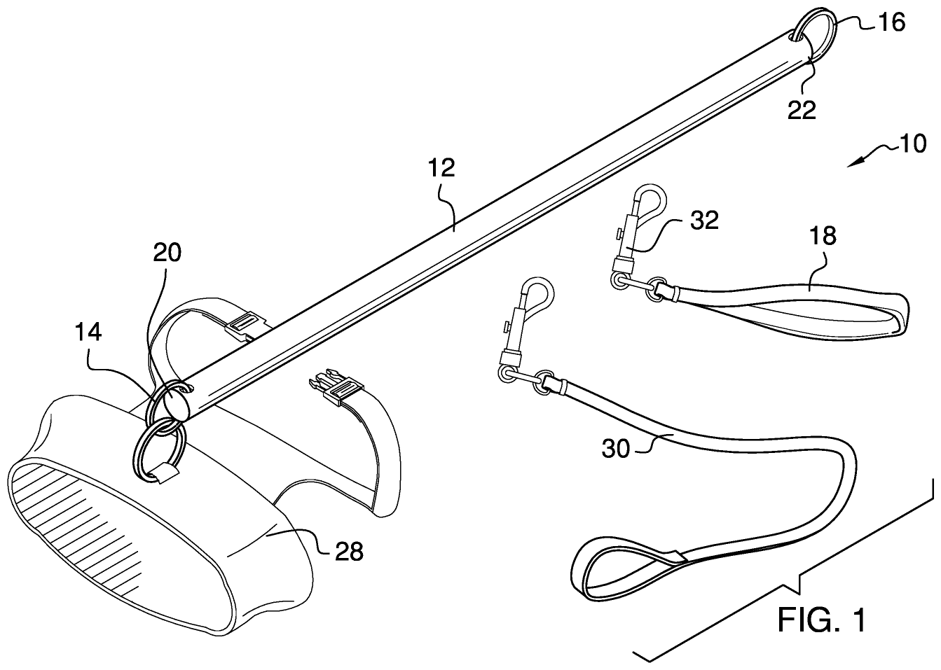

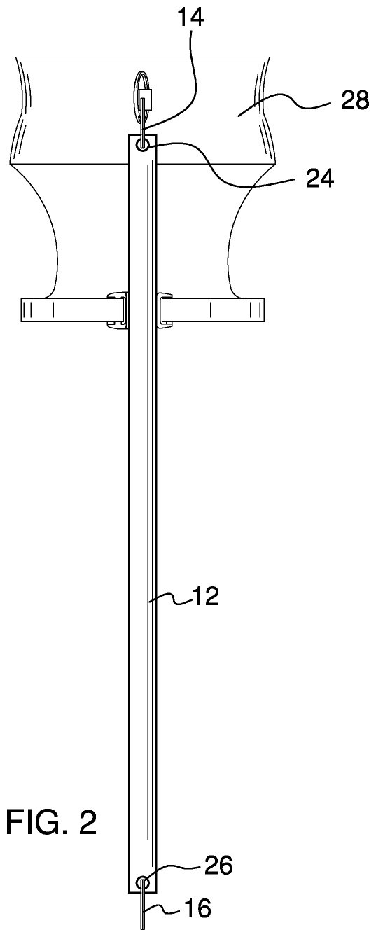

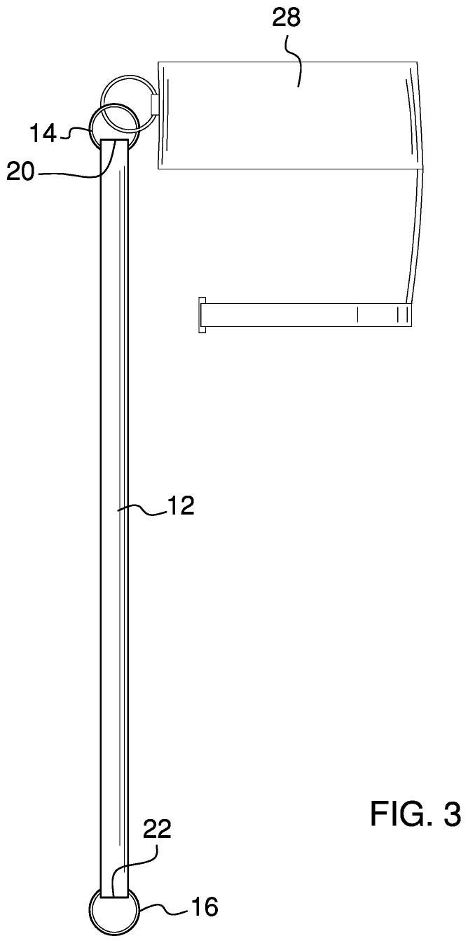

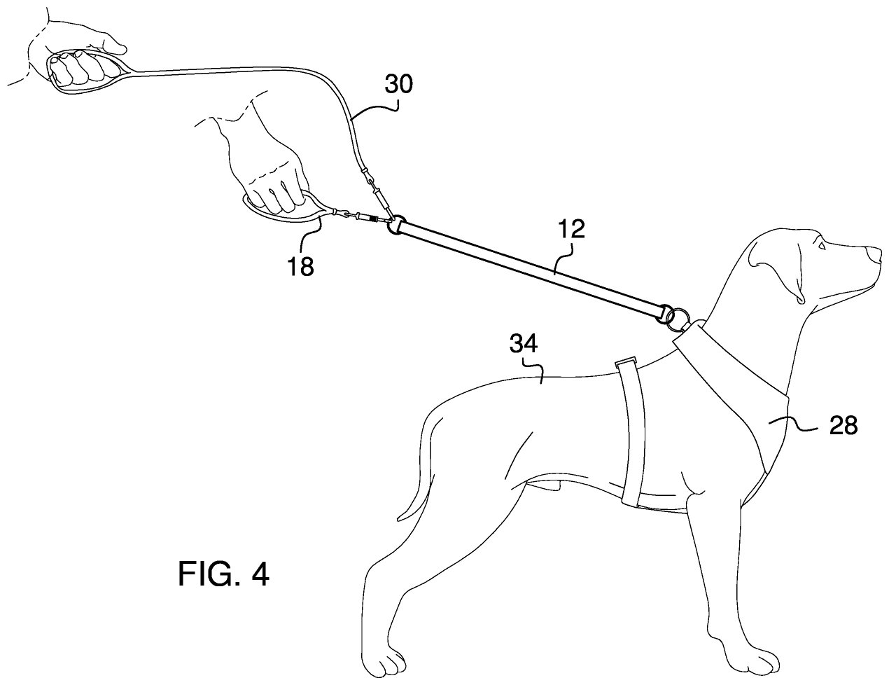

With reference now to the drawings, and in particular to FIGS. 1 through 4 thereof, a new leash accessory embodying the principles and concepts of an embodiment of the disclosure and generally designated by the reference numeral 10 will be described.

As best illustrated in FIGS. 1 through 4, the pet controlling leash extension 10 generally comprises an extension bar 12, a harness ring 14, a leash ring 16, and a handle 18. The extension bar 12 has a harness end 20 and a leash end 22. A harness aperture 24 extends through the harness end 20 and a leash aperture 26 extends through the leash end 22. The extension bar 12 may be telescopable. The extension bar 12 may be, but is not limited to, aluminum, steel, or plastic and may be coated with flexible rubber or plastic. The harness ring 14 is coupled to the harness aperture 24 and is configured to selectively engage with a harness 28. The leash ring 16 is coupled to the leash aperture 26 and is configured to receive a leash 30. The handle 18 has a handle clip 32. The handle clip 32 is selectively engageable with the leash ring 16. The extension bar 12 and the handle 18 may be produced in a variety of colors and prints.

In use, the extension bar 12 is coupled to the harness 28 on a dog 34 to allow the leash 30 to attach closer to the dog's tail to prevent tangling in the dog's legs. The handle 18 can then be used to exert greater control over the dog, or the leash 30 can be used to allow the dog 34 more freedom.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pet controlling leash extension comprising:
an extension bar, the extension bar having a harness end and a leash end;
a harness ring coupled to the extension bar, the harness ring being coupled to the harness end, the harness ring being configured to selectively engage with a harness;
a leash ring coupled to the extension bar, the leash ring being coupled to the leash end, the leash ring being configured to receive a leash; and
a handle coupled to the leash ring, the handle having a handle clip, the handle clip being selectively engageable with the leash ring.

2. The pet controlling leash extension of claim 1 further comprising the extension bar being telescopable.

3. The pet controlling leash extension of claim 1 further comprising the extension bar having a harness aperture extending through the harness end and a leash aperture extending through the leash end, the harness ring being coupled through the harness aperture and the leash ring being coupled through the leash aperture.

4. A pet controlling leash extension comprising:
an extension bar, the extension bar having a harness end and a leash end, a harness aperture extending through the harness end and a leash aperture extending through the leash end, the extension bar being telescopable;
a harness ring coupled to the extension bar, the harness ring being coupled to the harness aperture, the harness ring being configured to selectively engage with a harness;
a leash ring coupled to the extension bar, the leash ring being coupled to the leash aperture, the leash ring being configured to receive a leash; and
a handle coupled to the leash ring, the handle having a handle clip, the handle clip being selectively engageable with the leash ring.

5. A pet controlling leash extension system comprising:
a harness, the harness being configured to be worn by a dog;
an extension bar, the extension bar having a harness end and a leash end, a harness aperture extending through the harness end and a leash aperture extending through the leash end, the extension bar being telescopable;
a harness ring coupled to the extension bar, the harness ring being coupled to the harness aperture, the harness ring being selectively engageable with the harness;
a leash ring coupled to the extension bar, the leash ring being coupled to the leash aperture, the leash ring being configured to receive a leash; and
a handle coupled to the leash ring, the handle having a handle clip, the handle clip being selectively engageable with the leash ring.

6. The pet controlling leash extension system of claim 5, further comprising
a leash, the leash having a leash clip.
